(19) United States
(12) Patent Application Publication
(10) Pub. No.: US 2009/0271281 A1
(43) Pub. Date: Oct. 29, 2009

(54) Computer-implemented reservation system

(76) Inventor: Heemin Kang, Seoul (KR)

Correspondence Address: JACOBSON HOLMAN PLLC, 400 SEVENTH STREET N.W., SUITE 600, WASHINGTON, DC, 20004, US

(21) Appl. No.: 12/149,144

(22) Filed: Apr. 28, 2008

(51) Int. Cl. G06Q 30/00; G06F 7/06; G06F 17/30; G06F 3/048

(52) U.S. Cl. 705/26; 707/2; 715/760; 707/E17.016

(57) ABSTRACT

A Web service based, real-time booking engine in which reservations Web pages include a “One Click Search” implemented using a global navigation menu located in the Web pages, facilitating easy switch to search other destinations at any time. The reservations Web pages also include a reservation search form. From any of the Web pages, the customer can enter or change the destination by clicking on a destination in the global navigation menu. A new search is then performed using whatever other information was previously entered in the reservation search form. After a search, the booking engine remembers any changed traveling details including check-in date, number of nights, room types, etc., so the customer can jump to any other destination in the global navigation menu by simply selecting the destination in the global navigation menu at any stage of a booking process.

### CROSS-REFERENCE TO RELATED APPLICATIONS

Not applicable.

### COPYRIGHTED MATERIAL

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention relates to a computer-implemented reservation system. More specifically, the invention relates to a computer-implemented reservation system that includes a global navigation menu for implementing a “One Click Search.”

2. Related Art

There are numerous web sites that enable users to make reservations online and in real time. These web sites primarily relate to travel reservations. The user enters his or her search parameters and then submits them to obtain a list of matching search results. If at any point in the booking process the user wants to change any of the search criteria, for example to search for hotels in another city, conventional travel web sites leave no choice for the user but to start all over again from the beginning and re-enter his or her search criteria, particularly the city.

It is to the solution of these and other problems that the present invention is directed.

### SUMMARY OF THE INVENTION

It is accordingly a primary object of the present invention to provide a Web service based, real-time booking engine that includes a “One Click Search” to facilitate easy changing of search parameters.

It is another object of the present invention to provide a Web service based, real-time booking engine that carries forward search parameters from one search to another.

These and other objects of the invention are achieved in the context of a hotel reservation system by a Web service based, real-time booking engine in which reservations Web pages include a “One Click Search” that provides an easy-to-use user interface for customers looking for hotels. The One Click Search is implemented using a global navigation menu located in the Web pages, facilitating easy switch to search other destinations at any time. The reservations Web pages also include a reservation search form with a plurality of data entry fields, the contents of which vary depending upon the type of web page.

From any of the Web pages, the customer can enter or change the destination by clicking on a destination in the global navigation menu. A new search is then performed using whatever other information was previously entered in the data entry fields of the reservation search form. After a search, the booking engine remembers any changed traveling details including check-in date, number of nights, room types, etc., so the customer can jump to any other destination in the global navigation menu by simply selecting the destination in the global navigation menu at any stage of a booking process.

Other objects, features and advantages of the present invention will be apparent to those skilled in the art upon a reading of this specification including the accompanying drawings.

### BRIEF DESCRIPTION OF THE DRAWINGS

The invention is better understood by reading the following Detailed Description of the Preferred Embodiments with reference to the accompanying drawing figures, in which like reference numerals refer to like elements throughout, and in which: FIG. 1 is a diagram illustrating the general system architecture of the computer-implemented reservation system in accordance with the present invention.

FIG. 2 is an exemplary home web page.

FIG. 2A shows the home web page of FIG. 2 illustrating the auto-complete feature of the reservation search form's destination data entry field.

FIG. 3 is the upper portion of an exemplary results web page for a first destination.

FIG. 4 shows the arrangement of FIGS. 4A and 4B.

FIGS. 4A and 4B are upper and middle portions of an exemplary information web page for a hotel listed in the exemplary results web page of FIG. 3.

FIG. 5 is the upper portion of an exemplary results web page for a second destination.

FIG. 6 shows the arrangement of FIGS. 6A and 6B.

FIGS. 6A and 6B are upper and middle portions of an exemplary results web page for a third destination.

FIG. 7 is the upper portion of an exemplary results web page resulting from narrowing the results displayed in the exemplary results web page shown in FIGS. 6A and 6B.

FIG. 8 is the upper portion of an exemplary results web page for a third destination.

FIG. 8A is the upper portion of the exemplary results web page of FIG. 8, in which an enlarged portion of the map of FIG. 8 is displayed.

FIG. 9 is a flow diagram illustrating the manner in which the search engine operates.

### DETAILED DESCRIPTION OF THE PREFERRED EMBODIMENTS

In describing preferred embodiments of the present invention illustrated in the drawings, specific terminology is employed for the sake of clarity. However, the invention is not intended to be limited to the specific terminology so selected, and it is to be understood that each specific element includes, all technical equivalents that operate in a similar manner to accomplish a similar purpose.

The present invention is described below with reference to flowchart illustrations of methods, apparatus (systems), and computer program products according to an embodiment of the invention. It will be understood that each block of the flowchart illustrations, and combinations of blocks in the flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

The present invention is preferably practiced within a client/server programming environment. As is known by those skilled in this art, client/server is a model for a relationship between two computer programs in which one program, the client, makes a service request from another program, the server, which fulfills the request. Although the client/server model can be used by programs within a single computer, it is more commonly used in a network where computing functions and data can more efficiently be distributed among many client and server programs at different network locations.

As is known to those with skill in this art, client/server environments may include public networks, such as the Internet, and private networks often referred to as “Intranets” and “Extranets.” The term “Internet” shall incorporate the terms “Intranet” and “Extranet” and any references to accessing the Internet shall be understood to mean accessing an Intranet and/or and Extranet, as well. The term “computer network” shall incorporate publicly accessible computer networks and private computer networks.

It is to be understood that the present invention is not limited to the illustrated user interfaces or to the order of the user interfaces described herein. Various types and styles of user interfaces may be used in accordance with the present invention without limitation.

The following definitions are used herein:

B2B—Business-to-business; describes transactions, particularly Internet marketing, between businesses (as opposed to marketing by businesses directly to consumers).

B2B2C—Business-to-business-to-consumer; describes transactions in which a business sells a service or product to a consumer using another business as an intermediary.

The reservation system 10 in accordance with the present invention provides an XML, Web service based real-time booking engine. Although the reservation system 10 is described herein in connection with the booking of hotel reservations, it is not hotel, or even travel industry specific, but as will be appreciated by those of skill in the art, it can be used to make reservations in any context where it is desired to link a supplier of reservations to a central data system, through which Internet customers can make real-time and instant reservations.

As shown in FIG. 1, the reservation system 10 in accordance with the present invention involves at least four different entity types: (1) suppliers 12 of reservations of goods or services (for example, hotel, rail, flight, or other travel reservations); (2) consumers 14 of the suppliers' reservations of goods or services (hereinafter referred to as “customers”); (3) agents 16 selling the suppliers' reservations to customers; and (4) a central database provider 18 maintaining a central data system 20 (which includes a database 20a of reservation information for the suppliers' goods or services, conventionally networked with web services 20b, web servers 20c, and a firewall 20d); and thus includes a B2B2C component and a B2B component. The B2B2C component permits the website of an agent 16 to link to the central database 20a to facilitate real-time and instant hotel booking confirmation for the agent's internet customers 14. The booking comes from the agent's own domain, so all transactions take place under the agent's brand, not the brand of the central database provider 18.

The B2B component facilitates on-line as well as off-line phone or walk-in bookings of the suppliers' reservations by customers 14 through the central database provider's website.

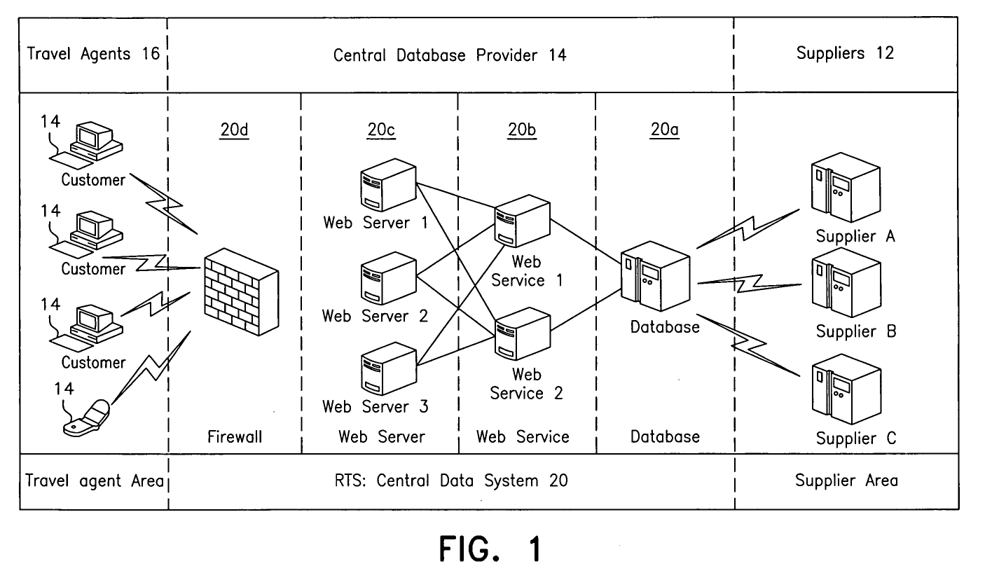

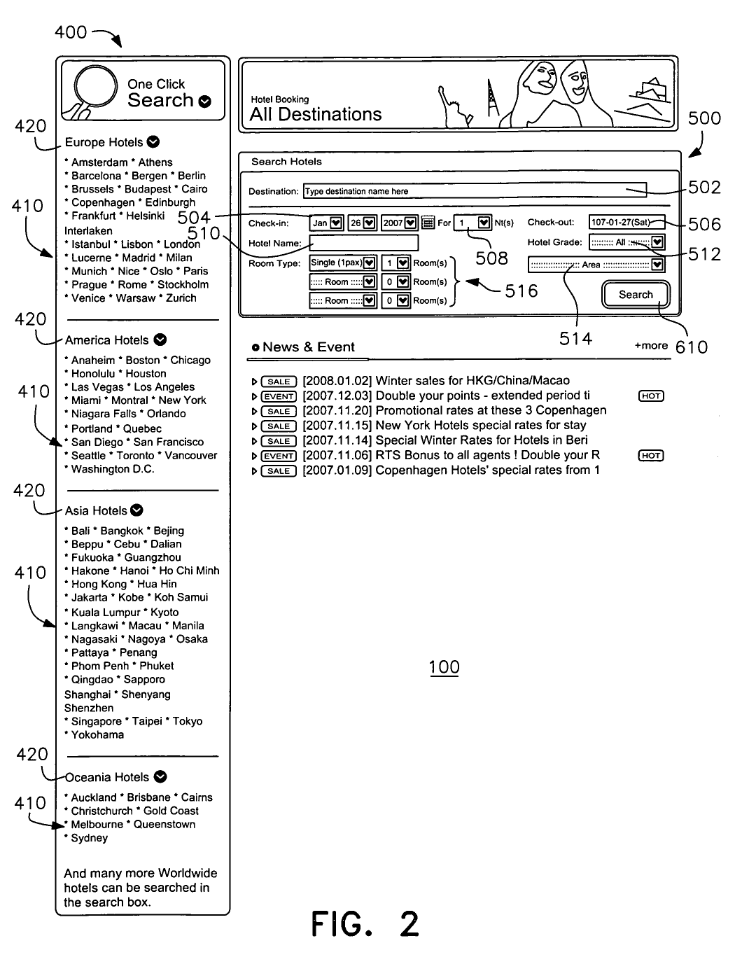

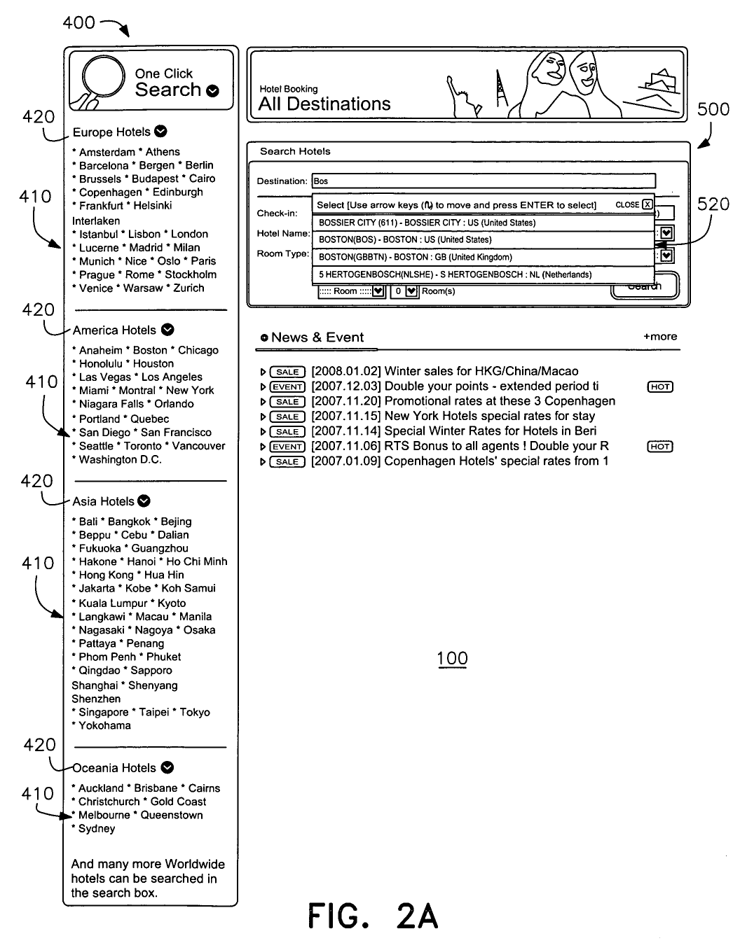

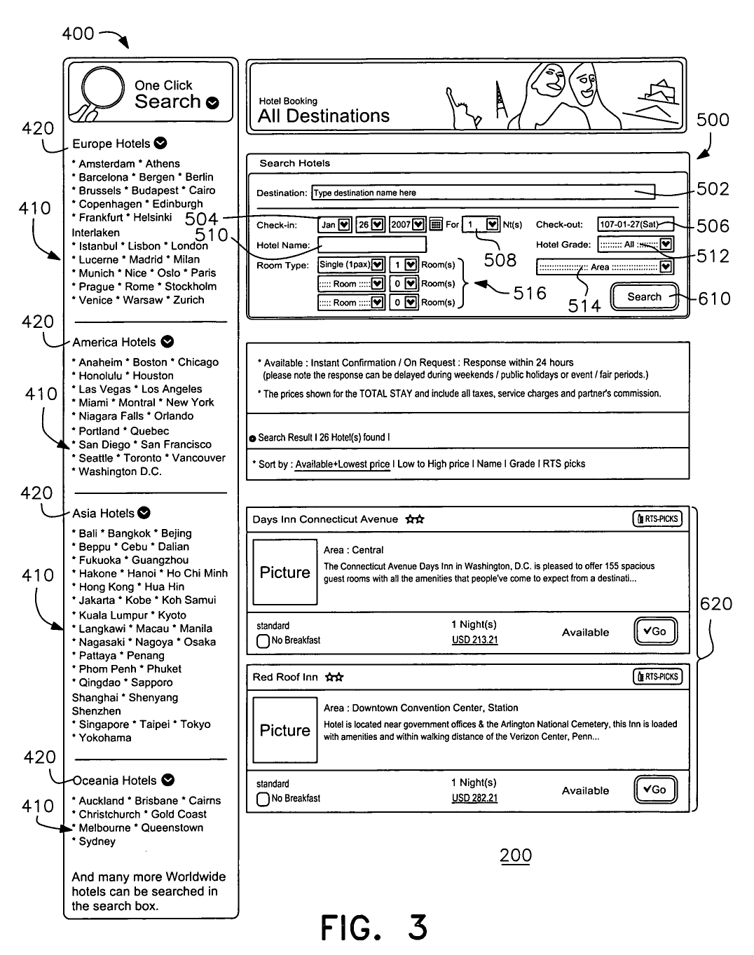

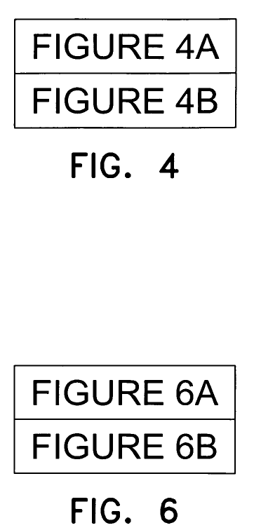

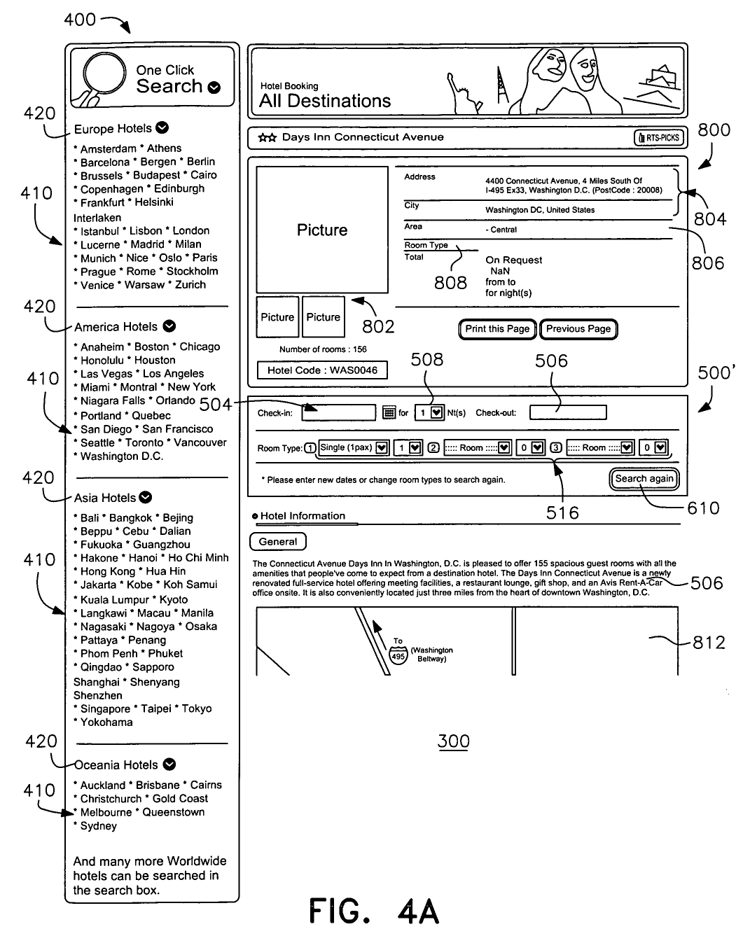

In both the B2B2C and the B2B components, there are at least three types of reservations web pages: (1) a home page 100 (shown in FIGS. 2 and 2A), (2) a results page 200 (shown in FIGS. 3, 6A, 6B, 7, 8, and 8A), and (3) an information page 300 (shown in FIGS. 4A and 4B). A customer 14 begins the booking process on the home page 100, in which the customer 14 inputs his or her choice of geographic destination parameter and optionally, other non-geographic search parameters, for example, hotel name, hotel grade, check-in and check-out dates, number of people, and number of rooms, as described in greater detail hereinafter.

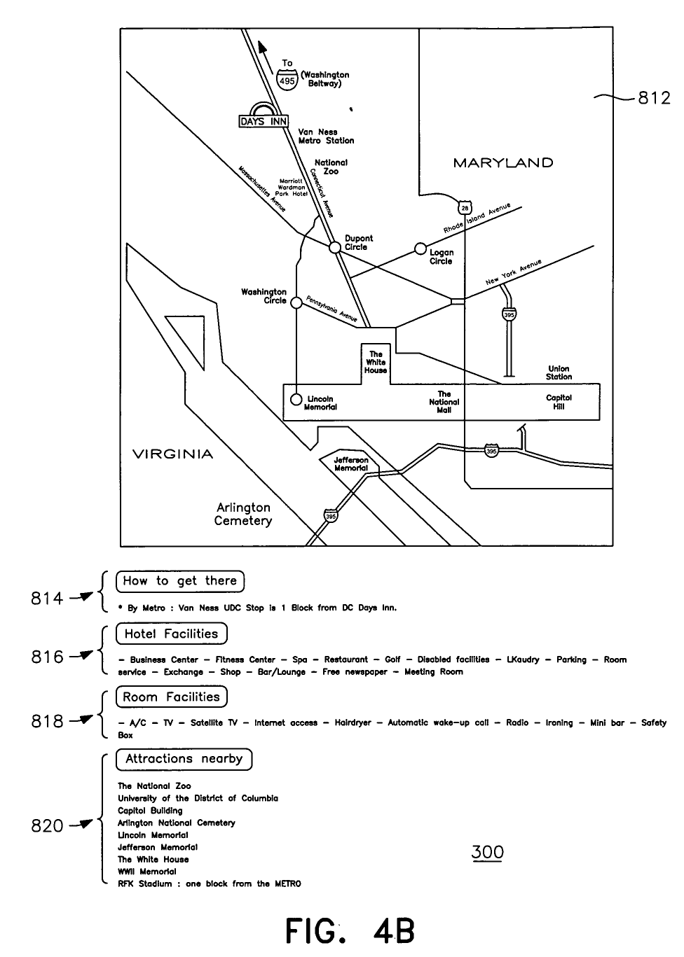

All reservations web pages 100, 200, and 300 in accordance with the present invention include a global navigation menu 400 for implementing a “One Click Search.” In the exemplary web pages shown in FIGS. 2, 2A, 3, 4A, 4B, 5, 6A, 6B, 7, 8, and 8A, the global navigation menu 400 is located on the left side. However, it will be appreciated by those of skill in the art that the global navigation menu 400 can be located elsewhere, such as at the top of the page, or even in multiple locations. In the example of hotel reservations, the global navigation menu 400 includes a list of destination cities 410 from which a customer 14 can select to search for hotel reservations. Where the number of items in the One Click Search menu is large, they can be grouped in categories 420, for example, as shown in FIGS. 2, 2A, 3, 4A, 4B, 5, 6A, 6B, 7, 8, and 8A, by geographic area or continent, which also can be selected to search for hotel reservations.

The reservations web pages also include one of two types of reservation search form: (1) a complete reservation search form 500 and (2) an abbreviated reservation search form 500′. The complete reservation search form 500 includes options for entering all search parameters (geographic and non-geographic). The data fields in an abbreviated reservation search form 500′ can vary depending upon the type of reservations web page on which it appears. In the context of a hotel reservation system, the home page 100 includes a complete reservation search form 500, with data fields for entering destination 502, destination check in date 504, check out date 506, number of nights 508, hotel name 510, hotel grade 512, area 514, and room type 516. The results page 200 also includes a complete reservation search form 500, which is the same as that on the home page 100. The hotel information page 300 includes an abbreviated reservation search form 500′, with data fields for entering various non-geographic search parameters, for example destination check in date 504, check out date 506, number of nights 508, and room type 506, but does not include a data field for entering a destination.

The “One Click Search” is available on all of the reservations, results, and hotel information pages 100, 200, and 300, enabling the customer 14 to enter or change the destination by clicking on a destination in the global navigation menu 400. A new search is then performed using whatever other information was previously entered in the data fields of the reservation search form 500 or 500′. After a search, the booking engine remembers any changed data including check-in date, number of nights, room types, etc., so the customer 14 can jump to any other city in the world by simply clicking the name of a destination in the global navigation menu 400 at any stage of a booking process.

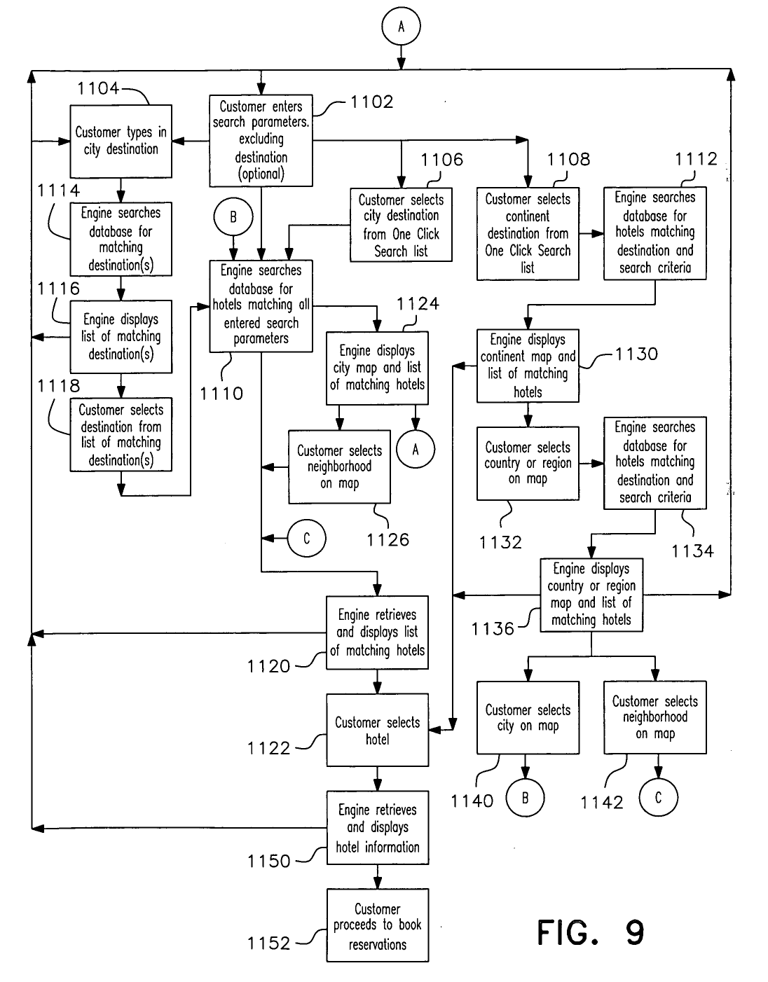

Referring now to the flow diagram of FIG. 9, there are four ways for a customer 14 to initiate a search: (i) the customer 14 can enter non-geographic search parameters (step 1102); (ii) the customer 14 can type in the full or partial name of a city parameter in a destination data entry field 502 in the reservation search form 500 (step 1104); (iii) the customer 14 can select a city parameter from the global navigation menu 400 (step 1106); or (iv) the customer 14 can select a geographic location parameter from the global navigation menu 400 (step 1108). If the customer 14 clicks on either a geographic location parameter or a city parameter in the global navigation menu 400, the booking engine automatically adds that parameter to the reservation search form and accesses the database 20a to perform a hotel search (steps 1110 and 1112). The customer 14 can switch to search another geographic location parameter or city parameter at any time by selecting a different geographic location parameter (step 1108) or city parameter (step 1106) in the global navigation menu 400. If the customer 14 types in either the full or partial name of a city parameter (step 1104), the search engine automatically searches a geographic location database in the database 20a for matching city parameters (step 1114), and (as shown in FIG. 2A) displays either a list of matching city parameters 520 (step 1116), from which the customer 14 can select (step 1118), or a message that no matching location has been found (not shown). Once a geographic location parameter or a city parameter is inserted into the destination data entry field 520 of the reservation search form 500, the booking engine automatically accesses the central database 20a at the central database provider 18 to obtain information associated with the requested destination (step 1110).

Either before or after inserting a geographic location, the customer 14 can add further non-geographic search parameters (step 1102) and submit the search by conventional means, such as clicking on a “submit” or “search” button 610 using a mouse or other pointing device. The booking engine then accesses the central database 20a at the central database provider 18 to obtain information associated with the request and determine whether any inventory in the database 20a matches the parameters of the request (step 1110). If so, as shown in FIG. 3, a list of matches 620 from the central database provider 18 is retrieved and displayed to the customer 14 on a results page 200 (step 1120). The customer 14 can then select one of the matches for display on the information page 300 (step 1122). Otherwise, a message is displayed advising the customer 14 that no matches have been found (not shown).

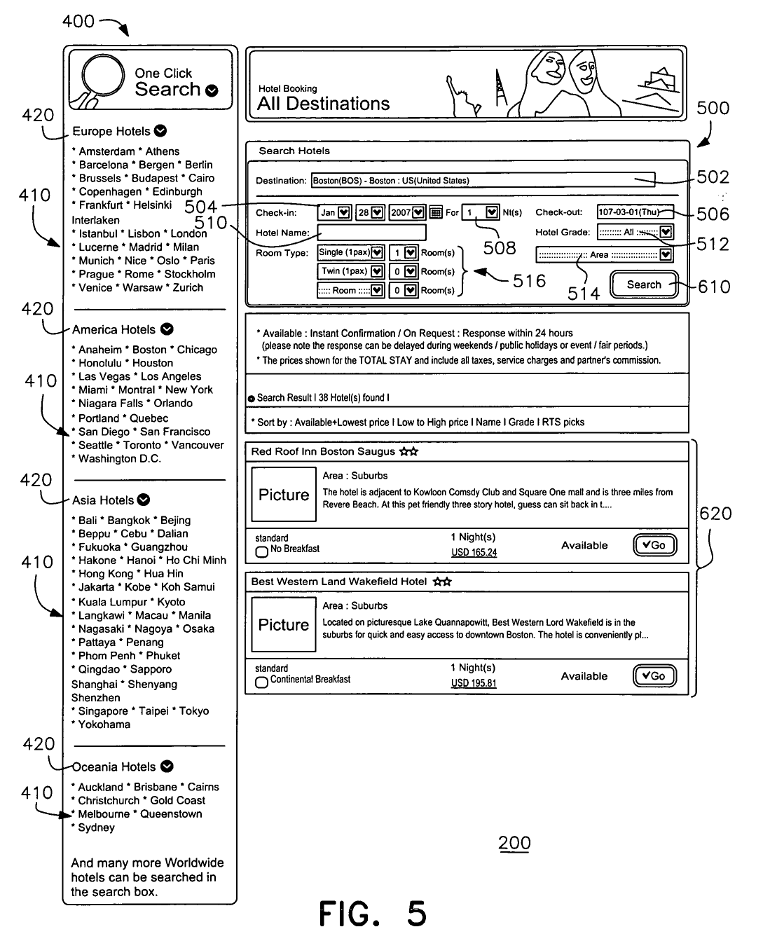

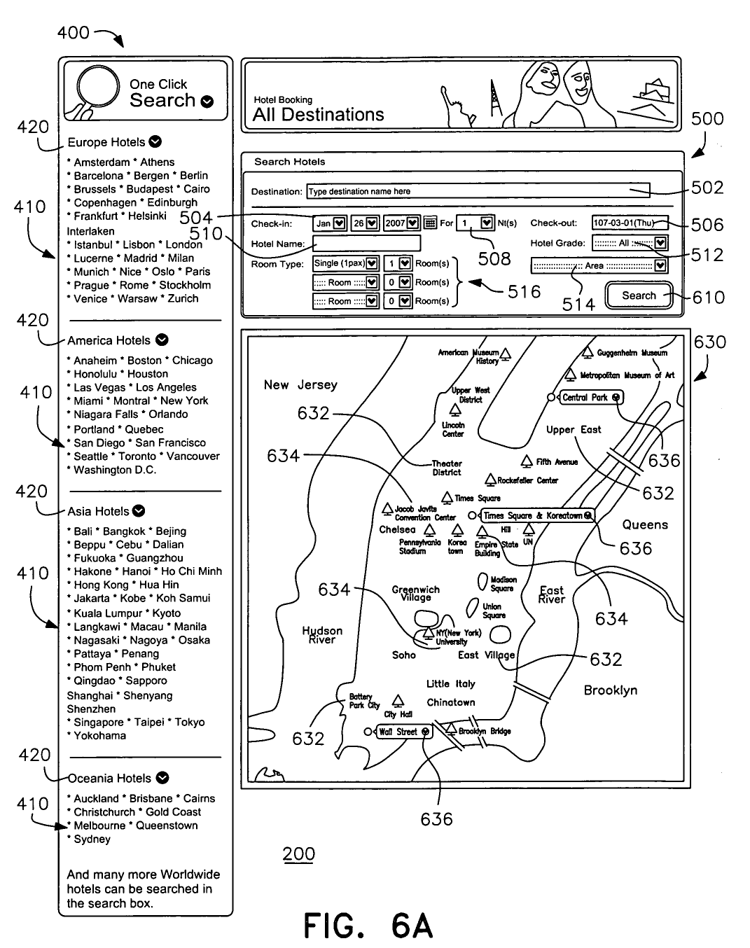

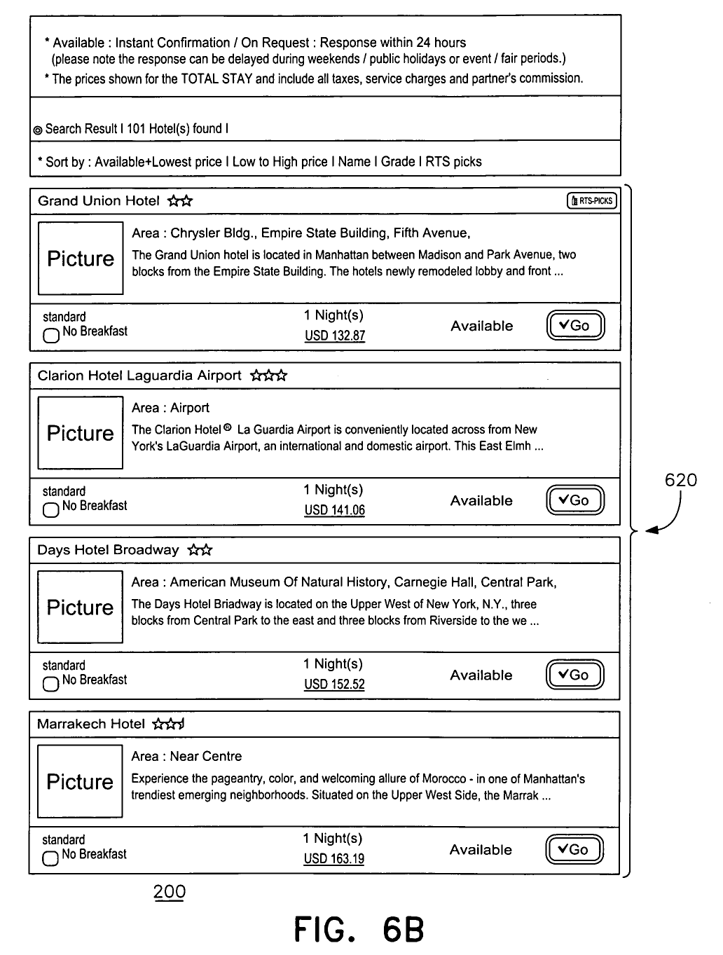

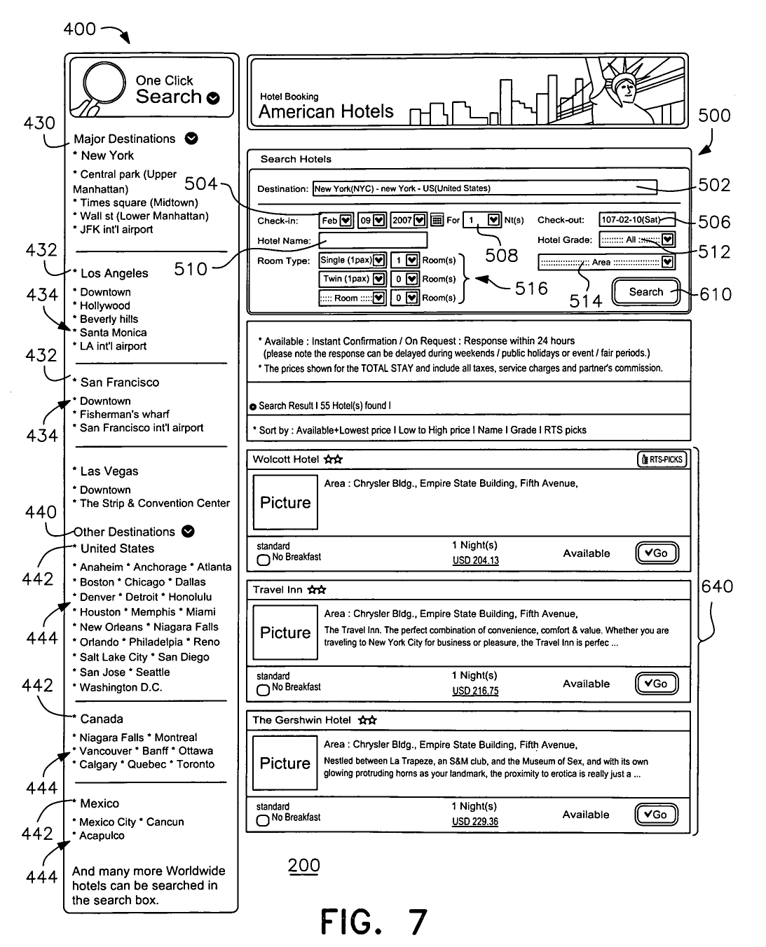

As shown in FIG. 6A, an interactive map 630 of the city can be provided on the results page 200, to facilitate the direct search of hotels in specific neighborhoods 632 on the map. This feature is particularly appropriate when there are a large number of matching hotels in the selected destination. The interactive map 630 displays the locations of neighborhoods 632, major tourist attractions/landmarks 634, and the like, at least some of which are associated with hyperlinks 636, each of which invokes its own server-side script; and thus allows the customer 14 to select one of the locations associated with a hyperlink. For example, with reference to FIGS. 6A and 6B, if the customer 14 selects “New York” as the geographic location, a script is invoked that displays a map of Manhattan, in which the names of three neighborhoods 632—Central Park, Times Square & Koreatown, and Wall Street—are associated with hyperlinks 636, each of which invokes its own server-side script. When the customer 14 clicks on one of the hyperlinks 636 (step 1126), the script will cause the booking engine to access the central database 20a at the central database provider 18 to obtain information associated with the request and determine whether any inventory in the database 20a matches the parameters of the request (step 1110); and to display a list of matching hotels 640 for the neighborhood 632 corresponding to the selected hyperlink (step 1120), as shown in FIG. 7.

Further, as shown in FIGS. 7 and 7A, the global navigation menu 400 changes to list major destinations 430, such as preselected major cities 432, and other destinations 440, such as countries 442, within the selected continent or geographic area. In order to allow the customer 14 to further refine his or her search using the global navigation menu 400, each preselected major city is provided with an associated list of its major neighborhoods 434, and each country 442 is provided with an associated list of its major cities 444.

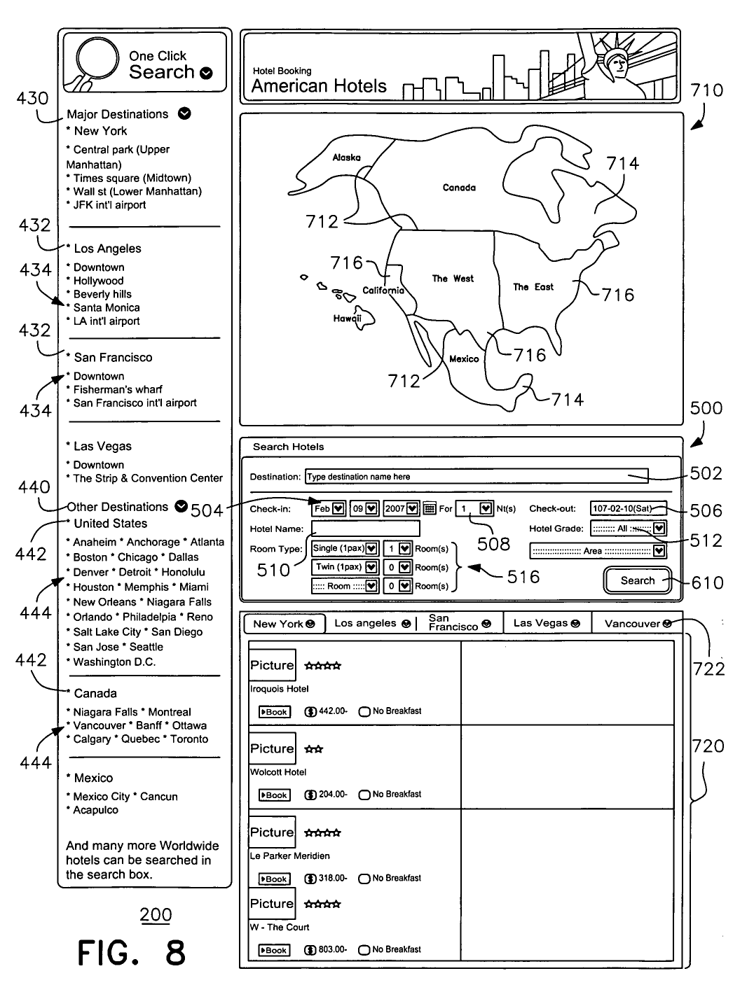

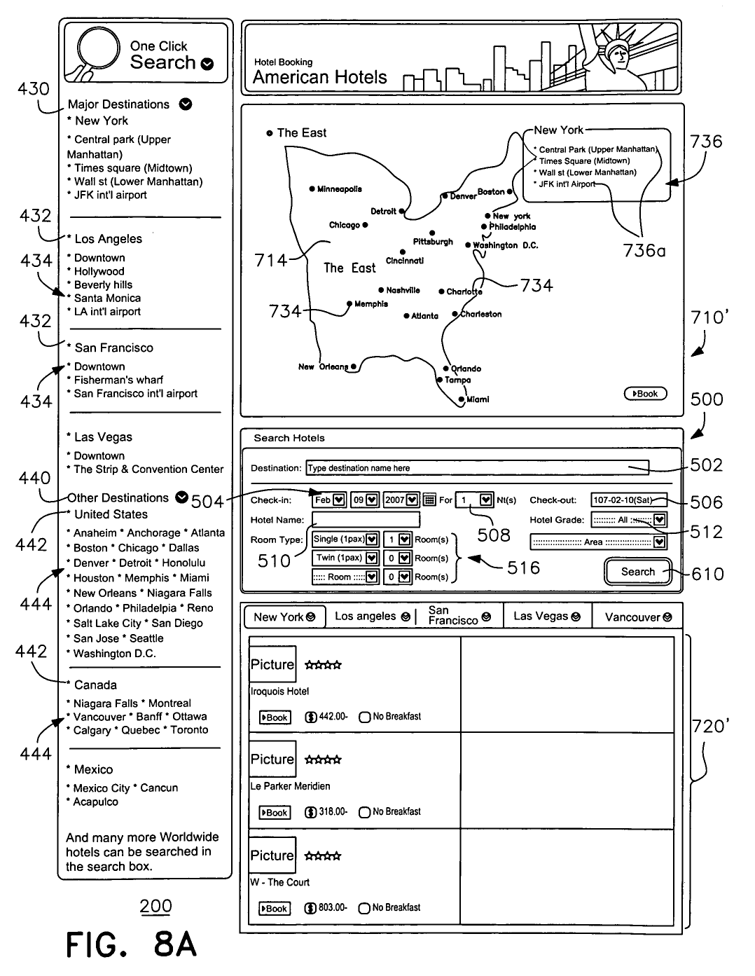

If a customer 14 clicks on a continent or geographic area in the global navigation menu 400 (step 1108), then as shown in FIG. 8, a server-side script associated with the continent or geographic area causes an interactive map 710 of the continent or geographic area to be displayed, along with a reservation search form, and also causes the booking engine to access the central database 20a at the central database provider 18 to retrieve a limited list of matching hotels 720 for the location corresponding to the selected hyperlink (step 1130). The list of matching hotels can be limited by restricting the search to preselected principle cities 734 in the continent or geographic area.

In the exemplary web page 200 shown in FIG. 8, the interactive continent or geographic map 710 is located to the right of the global navigation menu 400, at the top of the page, followed by the reservation search form 500 and the list of hotels 720, which are categorized by the preselected city in which they are located, the preselected cities being arranged as “clickable” tabs 722 on the web page.

The map 710 of the continent or geographic area is marked at least with the boundaries 712 of the countries 714 therein; and may further be marked to indicate geopolitical areas 716 within the countries. The interactive map 710 allows the customer 14 to select one of the displayed countries 714 or other geopolitical areas 716 on the map, each of which is associated with a hyperlink (step 1132) that invokes a script. For example, if the customer 14 selects “American hotels” as a destination, a map of North America is displayed (as shown in FIG. 8, in which the countries Canada and Mexico, the states of Alaska, California, and Hawaii, and the East (i.e., the eastern U.S.) and the West (i.e., the western U.S.)—are associated with hyperlinks, each of which invokes a script. The customer 14 can also select a hotel in the displayed list 720 (step 1122), as described above.

When the customer 14 clicks on one of the hyperlinks, then a server-side script is invoked to cause the booking engine again to access the central database 20a at the central database provider 18 to obtain information associated with the request and determine whether any inventory in the database 20a matches the parameters of the request (step 1134); and as shown in FIG. 8A, to display a more detailed, interactive map 710′ of the selected country or geopolitical area in place of the map of the continent or geographic area, along with a list of matching hotels 720′ for the country or geopolitical area corresponding to the selected hyperlink (step 1136). The customer 14 again can select a hotel in the displayed list (step 1122), as described above.

The more detailed, interactive map 710′ also allows the customer 14 to select one of a number of displayed cities 734 on the map, each of which is associated with a hyperlink (step 1140), and for large cities, also to select one of a number of neighborhoods 736a displayed in an associated list 736b, each of the listed neighborhoods 736a also being associated with a hyperlink (step 1142), in the same manner as described above with respect to the map 630 in FIG. 6A. Each of these hyperlinks is associated with a server-side script that causes the booking engine automatically to add that parameter to the reservation search form 500 and to access the database 20a to perform a hotel search (steps 1110 and 1112), as described above.

Once the customer 14 selects a hotel (step 1122), the booking engine retrieves and displays a results web page 300 with information 800 relating to the hotel (step 1150), as shown in FIGS. 4A and 4B. The hotel information 800 can include, but is not limited to, photos 802, the address 804, the area 806, room type 808, a general description 810, a location map 812, directions 814, a list of hotel facilities 816, a list of room facilities 818, nearby attractions 820, etc. The customer 14 can then proceed to book reservations (step 1152) or to change any of the search parameters to perform a new search.

For B2B2C applications, the booking engine can be customized with an agent's own company name and logo, and with a localized, tailor-made and simplified user interface according to the varied needs of the agent's target audience (customers), using known programming techniques.

The booking engine provides live inventories from suppliers 12 using XML/Web Service host-to-host interfacing technology.

The central database provider 18 may elect to contract only with those suppliers 12 that it has pre-screened and determined to provide services meeting its quality and/or other criteria. The hotel reservation system 10 thus can provide a multi-supplier based auto-price-bidding system that provides agents 16 with a wide-range of inventory (for example, hotel rooms) with competitive pricing, as well as carefully-selected reputable suppliers 12 of products or services (for example, hotels) all around the world. With multi-supplier capability, the booking engine will automatically select the available inventory (for example, hotels and hotel rooms) with the lowest price for display to the customer 14. This ensures room availability at all times with the best price; and that rooms at “On Request” hotels will also be at available at their best price.

One click is sufficient to enable a customer 14 to look at the inventories of major cities around the world. The booking engine makes the search and booking process easier and faster than conventional booking systems because the customer 14 does not have to waste time keying in the same search criteria whenever he or she wants to make other searches. The customer 14 can move across cities and continents at any point in the booking process with the same search criteria (for example, dates and room type) previously made during the booking process.

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

What is claimed is:

1. A computer program product for a reservation system, the computer program product comprising a computer usable storage medium having computer readable program code means embodied in the medium, the computer readable program code means comprising:
computer readable program code means for displaying a global navigation menu on a web page, the global navigation menu including a list of geographic location parameters;
computer readable program code means for displaying a search form on the web page, the search form having a plurality of data entry fields;
computer readable program code means for enabling a customer to select one of the geographic location parameters in the list and to change from a first selected geographic location to a new selected geographic location;
computer readable program code means for enabling the customer to input non-geographic search parameters into the data entry fields of the search form;
computer readable program code means for searching a database for inventory in the database matching the geographic parameter selected by the customer and the non-geographic parameters input by the customer; and
computer readable program code means for conducting a new search of the database for inventory in the database matching the non-geographic parameters input by the customer and a new geographic location parameter selected by the customer from the global navigation menu, without the customer reentering the non-geographic parameters.

2. A computer-implemented reservation system, comprising:
means for displaying a global navigation menu on a web page, the global navigation menu including a list of geographic location parameters;
means for displaying a search form on the web page, the search form having a plurality of data entry fields;
means for enabling a customer to select one of the geographic location parameters in the list and to change from a first selected geographic location to a new selected geographic location;
means for enabling the customer to input non-geographic search parameters into the data entry fields of the search form;
means for searching a database for inventory in the database matching the geographic parameter selected by the customer and the non-geographic parameters input by the customer; and
means for conducting a new search of the database for inventory in the database matching the non-geographic parameters input by the customer and a new geographic location parameter selected by the customer from the global navigation menu, without the customer reentering the non-geographic parameters.

3. A display system for displaying web pages accessible via a network, the display system comprising:
a web page display having:
(a) a global navigation menu on the left side of the display, the global navigation menu including a list of geographic location parameters; and
(b) a search form on the web page, the search form having a plurality of data entry fields, the search form being to the right of the global navigation menu.

4. The display system of claim 3, the web page display further having a listing of hotels in a destination selected by a user, the listing of hotels being to the right of the global navigation menu and below the search form.

5. The display system of claim 4, the web page display further having an interactive map of the destination, the interactive map being to the right of the global navigation menu between the search form and the listing of hotels.

6. The display system of claim 3, further comprising a computer system configured to send requests for web pages via the network to web page sites, the computer system configured to receive web pages via the network from web page sites.
